(19) United States
(12) Patent Application Publication
(10) Pub. No.: US 2024/0248036 A1
(43) Pub. Date: Jul. 25, 2024

(54) METHOD AND DEVICE FOR ANALYZING A BIOLOGICAL SAMPLE

(71) Applicant: LEICA MICROSYSTEMS CMS GMBH, Wetzlar (DE)

(72) Inventor: Soeren ALSHEIMER, Wetzlar (DE)

(21) Appl. No.: 18/561,757

(22) PCT Filed: May 19, 2021
(86) PCT No.: PCT/EP2021/063310

§ 371 Date: Nov. 17, 2023

(51) Int. Cl. G01N 21/64

(52) U.S. Cl. CPC G01N 21/6428; G01N 21/6408; G01N 21/6458; G01N 2021/641; G01N 2021/6419; G01N 2021/6421; G01N 2021/6441

(57) ABSTRACT

A method for analyzing a biological sample (1002) comprises: Providing a plurality of markers (1612), each marker (1300 to 1309, 1400 to 1422, 1500 to 1508, 1518, 1526) comprising a fluorescent dye (1320) unique to the marker (1300 to 1309, 1400 to 1422, 1500 to 1508, 1518, 1526) and an affinity reagent (1310 to 1319) unique to the marker (1300 to 1309, 1400 to 1422, 1500 to 1508, 1518, 1526), the affinity reagent (1310 to 1319) being configured to attach to a predetermined structure (1706 to 1714) within the sample (1002). Staining the sample (1002) by introducing the plurality (1612) of markers into the sample (1002). Directing first excitation light having a first wavelength spectrum onto the sample (1002) in order to excite the fluorescent dyes (1320) of a first set of markers (1614). Generating at least one first image from fluorescence light emitted by the excited dyes of the first set (1614), the first image comprising at least two channels, each channel corresponding to one marker (1300 to 1309, 1400 to 1422, 1500 to 1508, 1518, 1526) of the first set of markers (1614). Directing at least one second excitation light having a second wavelength spectrum onto the sample (1002) in order to excite the fluorescent dyes (1320) of a second set of markers (1616), the second set (1616) being distinct from the first set (1614). Generating at least one second image from fluorescence light emitted by the excited dyes of the second set (1616), the second image comprising at least two channels, each channel corresponding to one marker (1300 to 1309, 1400 to 1422, 1500 to 1508, 1518, 1526) of the second set of markers (1616).

### CROSS REFERENCE TO RELATED APPLICATIONS

This application is a U.S. National Phase application under 35 U.S.C. § 371 of International Application No. PCT/EP2021/063310, filed on May 19, 2021. The International Application was published in English on Nov. 24, 2022 as WO 2022/242849 A1 under PCT Article 21(2).

### TECHNICAL FIELD

Embodiments of the present invention relate to a method for analyzing a biological sample. Embodiments of the present invention also relate to a device for analyzing a biological sample.

### BACKGROUND

In order to address key problems in the field of life sciences it is vital to precisely identify and to locate certain structures within biological samples, e.g. tissue samples or cell cultures. This can be done by introducing markers into the sample that bind to specific structures, e.g. specific biomolecules. These markers typically comprise an affinity reagent that attaches to the structure in question and a fluorescent dye that is either directly conjugated to the affinity reagent or attached to the affinity reagent by means of a secondary affinity reagent. They are various techniques for analysing biological samples prepared this way. The known techniques either have a high spatial resolution or can identify a high number of different fluorescent dyes. However, no technique allows for imaging a high number different fluorescent with high spatial resolution.

Fluorescence microscopy allows for imaging the sample with high spatial resolution but involves only a low number of different fluorescent dyes, typically between 1 and 5. The available markers have to accommodate markers that are used to identify cell types, functional markers like protein-of-interest and general morphological markers in the same experiment. This means that cell types in most imaging experiments are merely poorly identified. This means that rather broad multi cell type populations are being studied, which severely limits the predictive power and translational value of the results generated. While modern approaches that allow for a much more reliable and robust identification of cell types, e.g. based on the analysis of genetic regulatory networks (GRNs), exist they require a much higher number of different markers to be read-out from the sample.

While in the adjacent field of cytometry, mass cytometry and imaging mass cytometry techniques can distinguish between around 12 to 30 different markers, they do so with a low spatial resolution.

Spatial profiling techniques can distinguish a number of different markers several orders of magnitude higher, albeit at an even lower spatial resolution as they are based on hybridizing oligonucleotides to the sample and then selectively releasing bound oligonucleotides in a region-selective fashion followed by next-generation sequencing of the released oligonucleotides.

### SUMMARY

Embodiments of the present invention provide a method for analyzing a biological sample. The method includes providing a plurality of markers. Each marker includes a fluorescent dye unique to the marker and at least one affinity reagent unique to the marker. The at least one affinity reagent is configured to attach to a predetermined structure within the biological sample. The method further includes staining the biological sample by introducing the plurality of markers into the biological sample, directing first excitation light having a first wavelength spectrum onto the biological sample in order to excite the fluorescent dyes of a first set of markers, and generating at least one first image from fluorescence light emitted by the excited fluorescent dyes of the first set of markers. The first image includes at least two channels, each channel corresponding to a respective marker of the first set of markers. The method further includes directing at least one second excitation light having a second wavelength spectrum onto the biological sample in order to excite the fluorescent dyes of a second set of markers, the second set of markers being distinct from the first set of markers, and generating at least one second image from fluorescence light emitted by the excited fluorescent dyes of the second set of markers. The second image includes at least two channels, each channel corresponding to a respective marker of the second set of markers.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 is a flowchart of a method for analyzing a biological sample according to some embodiments;

FIG. 2 is a flowchart further detailing a step of the method according to FIG. 1, according to some embodiments;

FIG. 3 shows two diagrams of excitation and emission spectra of five different fluorescent dyes according to some embodiments;

FIG. 4 shows two diagrams of different excitation and emission spectra of five fluorescent dyes with different amounts of Stokes shift according to some embodiments;

FIG. 5 is a diagram of fluorescence emission decay curves of four different fluorescent dyes according to some embodiments;

FIG. 6 shows two diagrams of different excitation and emission spectra of fifteen fluorescent dyes grouped into three classes by their fluorescence lifetime according to some embodiments;

FIG. 7 is a diagram showing the total number of markers that can be reliably distinguished, according to some embodiments;

FIG. 8 is a table listing properties of different commercially available fluorescence dyes;

FIG. 9 is a diagram displaying the fluorescence lifetime of different fluorescence dyes according to some embodiments;

FIG. 10 shows a schematic drawing of a device for analyzing a biological sample according to some embodiments;

FIG. 11 is a schematic drawing of an imaging unit of the device according to FIG. 10, according to an embodiment;

FIG. 12 is a schematic drawing of an imaging unit of the device according to FIG. 10, according to another embodiment;

FIG. 13 is a schematic drawing of six markers each comprising an affinity reagent, and a fluorescent dye, according to some embodiments;

FIG. 14 is a schematic drawing of twelve markers each comprising an affinity reagent, and a non-fluorescent dye, according to some embodiments;

FIG. 15a is a schematic drawing of five markers each comprising a secondary affinity reagent, according to some embodiments;

FIG. 15b is a schematic drawing of a primary affinity reagent, bound by a secondary affinity reagent, which is barcoded by a covalently linked oligonucleotide, that serves as template for a rolling circle DNA amplification which amplifies the target sequence for a plurality of dye-conjugated oligonucleotides, according to some embodiments;

FIG. 15c is a schematic drawing of a primary affinity reagent, bound by a secondary affinity reagent, which is carries a covalently linked horse radish peroxidase enzyme, which catalyzes the formation of a dye-conjugated tyramide radical, which couples covalently to nearby tyrosine residues on the target protein owing to its short half-life, according to some embodiments;

FIG. 16a is a schematic drawing of two fluorescent dyes according to some embodiments;

FIG. 16b is a schematic drawing of a plurality of markers according to some embodiments; and

FIG. 17 is a schematic drawing of all cell according to some embodiments.

### DETAILED DESCRIPTION

Embodiments of the present invention provide a method and a device for analyzing a biological sample that allow analyzing an increased number of sets of markers with high spatial resolution.

The method for analyzing a biological sample comprises the following steps: a) Providing a plurality markers, each marker comprising a fluorescent dye unique to the marker and an affinity reagent unique to the marker, the affinity reagent being configured to attach to a predetermined structure within the sample. b) Staining the sample by introducing the plurality of markers into the sample. Directing first excitation light having a first wavelength spectrum onto the sample in order to excite the fluorescent dyes of a first set of markers. Generating at least one first image from fluorescence light emitted by the excited dyes of the first set, the first image comprising at least two channels, each channel corresponding to one marker of the set of markers. Directing at least one second excitation light having a second wavelength spectrum onto the sample in order to excite the fluorescent dyes of a second set of markers, the second set being distinct from the first set. Generating at least one second image from fluorescence light emitted by the excited dyes of the second set, the second image comprising at least two channels, each channel corresponding to one marker of the second set of markers.

Each marker targets its unique fluorescent dye to its predetermined structure within the biological sample, e.g. a specific biomolecule. Thereby, the markers make the structure visible to fluorescence imaging. The plurality of markers is separated into at least two sets, namely the first set, comprising fluorescent dyes excited by the first excitation light, and at least the second set, comprising fluorescent dyes excited by the second excitation light. This means, that each set may be excited independently by a different excitation light and, thus, fluorescence light emitted by each set may also be detected independently. This is used to generate the at least two images of the biological sample, each capturing fluorescence light emitted by a different set. In each image different fluorescent dyes are excited, and thus different structures of the sample are visible. The fluorescence light captured in each image is further separated into the different channels, each channel corresponding to a single marker. The images and/or channels may then be combined into a single image comprising more channels than would be possible to capture with a single image.

Thus, the method described above vastly increases the number of markers that can be imaged without requiring to remove or to deactivate the previous markers, and without additional staining. If for example each set comprises y markers, and n different excitation lights are used for generating n different images, the number of unique markers that can be imaged is n×y. Further, the method is easily adapted in a fluorescence microscope, allowing to image the biological sample with very high spatial resolution.

The method is easily adapted to capture additional images of the sample. For this purpose, additional excitation light having an additional wavelength spectrum is directed onto the sample in order to excite the fluorescent dyes of an additional set of markers. The additional set is distinct from the other sets. The additional image is then generated from fluorescence light emitted by the excited dyes of the additional set. The additional image comprises at least two channels, each channel corresponding to one marker of the additional set of markers.

The affinity reagent may in particular be an antibody, a single-domain antibody (also known as nanobody), a combination of at least two single-domain antibodies, an aptamer, an oligonucleotide complementary to a predetermined target sequence, a ligand or a toxin, e.g. Phalloidin a toxin that binds to an actin filament.

In this document the word marker is used to denote both a single molecule used as marker and a collection of identical molecules used as marker. Further, the terms “fluorescent dye”, “fluorophore”, “fluorochrome” are used interchangeably to denote a fluorescent chemical compound or structure. In particular, one of the following an organic fluorescent dye, a fluorescent quantum dot, a fluorescent carbon dot, graphene quantum dot or other carbon-based fluorescent nanostructure, a fluorescent protein, a fluorescent DNA origami-based nanostructure. Of the organic fluorescent dyes, derivatives of the following are meant in particular: xanthene (e.g. fluorescein, rhodamine, Oregon green, Texas), cyanine (e.g. cyanine, indocarbocyanine, oxacarbocyanine, thiacarbocyanine, merocyanine), derivatives, squarine rotaxane derivatives, naphthalene, coumarin, oxadiazole, anthracene (anthraquinones, DRAQ5, DRAQ7, CyTRAK Orange), pyrene (cascade blue), oxazine (Nile red, Nile blue, cresyl violet, oxazine 170), acridine (proflavine, acridine orange, acridine yellow), arylmethine (auramine, crystal violet, malachite green), tetrapyrrole (porphin, phthalocyanine, bilirubin), dipyrromethene (BODIPY, aza-BODIPY). The following trademark groups designate commercially available fluorescent dyes, which may include dyes belonging to different chemical families CF dye (Biotium), DRAQ and CyTRAK probes (BioStatus), BODIPY (Invitrogen), EverFluor (Setareh Biotech), Alexa Fluor (Invitrogen), Bella Fluore (Setareh Biotech), DyLight Fluor (Thermo Scientific), Atto and Tracy (Sigma-Aldrich), FluoProbes (Interchim), Abberior Dyes (Abberior Dyes), Dy and MegaStokes Dyes (Dyomics), Sulfo Cy dyes (Cyandye), HiLyte Fluor (AnaSpec), Seta, SeTau and Square Dyes (SETA BioMedicals), Quasar and Cal Fluor dyes (Biosearch Technologies), SureLight Dyes (Columbia Biosciences), Vio Dyes (Milteny Biotec). The aforementioned list was adapted from en.wikipedia.org/wiki/Fluorophore. From the group of fluorescent proteins, the members of the green fluorescent protein (GFP) family including GFP and GFP-like proteins (e.g DsRed, TagRFP) and their (monomerized) derivatives (e.g., EBFP, ECFP, EYFP, Cerulaen, m Turquoise2, YFP, EYFP, mCitrine, Venus, YPet, Superfolder GFP, mCherry, mPlum) are meant in particular by the term “fluorescent dye” in the sense of this document. Further from the group of fluorescent proteins the term “fluorescent dye” in the sense of this document may include fluorescent proteins, whose absorbance or emission characteristics change upon binding of ligand like for example BFPms1 or in response to changes in the environment like for example redox-sensitive roGFP or pH-sensitive variants. Further from the group of fluorescent proteins the term “fluorescent dye” in the sense of this document may include derivative of cyanobacterial phycobiliprotein small ultra red fluorescent protein smURFP as well as fluorescent protein nanoparticles that can be derived from smURFP. An overview of fluorescent proteins can be found in Rodriguez et al 2017 in Trends Biochem Sci. 2017 February; 42(2): 111-129. The term “fluorescent dye” in the sense of this document may further refer to a fluorescent quantum dot. The term “fluorescent dye” in the sense of this document may further refer to fluorescent carbon dot, a fluorescent graphene quantum dot, a fluorescent carbon-based nanostructure as described in Yan et al. 2019 in Microchimica Acta (2019) 186: 583 and Iravani and Varma 2020 in Environ Chem Lett. 2020 Mar. 10: 1-25.

In a preferred embodiment at least one marker comprises a fluorescent dye unique to the marker and conjugated to an affinity reagent unique to the marker. The affinity reagent is configured to attach to a predetermined structure within the sample. Directly attaching, e.g. by chemically linking, the fluorescent dye to the affinity reagent reduces the number of reactions that need to happen until the fluorescent dye is linked to the predetermined structure. Thereby, time is saved. It further reduces noise and limits the possibility of cross-reactivity, which would introduce errors into the analysis. In case the affinity reagent is an antibody or single-domain antibody this is also known as primary or direct immunofluorescence.

In another preferred embodiment at least one marker comprises a fluorescent dye unique to the marker, a primary affinity reagent unique to the marker, and a secondary affinity reagent unique to the marker. The fluorescent dye is conjugated to the secondary affinity reagent. The primary affinity reagent is configured to attach to a predetermined structure within the sample. The secondary affinity reagent is configured to attach to the primary affinity reagent. This way, multiple secondary affinity reagents can attach to a single primary affinity reagent, thereby boosting the overall signal strength and making the analysis more reliable. In case the affinity reagent is an antibody or single-domain antibody this is also known as secondary or indirect immunofluorescence.

In another preferred embodiment the following steps are repeated at least twice in order to create a series of images of the sample: Staining the sample. Directing the first excitation onto the sample. Generating the first image. Directing the second excitation onto the sample. Generating the second image. The steps defined in claim 1 describe a single round of image acquisition. Additional rounds may be performed in order to acquire a series of images of the sample. In particular, the series of subsequent images may be used in order to observe changes in the sample that occur over time.

In another preferred embodiment the method further comprises a step of deactivating at least one of the plurality of markers, at least one set of markers, at least one marker. In this document, deactivating one or more markers means preventing the associated fluorescent dye from emitting fluorescence light from the sample in the future. This can be done by either removing the fluorescent dye from the sample or by bleaching the fluorescent dye. Thereby, crosstalk between fluorescent dyes associated with different sets of markers is greatly reduced. In other words, by deactivating a set of markers, the structure marked by said set will not be visible in future images. This means, for example, that fluorescent dyes with similar emission spectra may be used in subsequent images, thereby, increasing the number of overall markers that can be used in a single round, a single experiment and/or with a single biological sample.

Preferably, the deactivating step is done by at least one of bleaching the fluorescent dye unique to the at least one marker and removing the at least one marker from the sample, preferably by at least one of dissociating or cleaving the fluorescent dye from the affinity reagent or dissociating the affinity reagent from the target structure.

In another preferred embodiment the step of generating the channels is based on at least one of spectral unmixing, a fluorescence lifetime of the fluorescent dyes and an excitation fingerprint of the fluorescent dyes. Spectral unmixing (also referred to as spectral imaging and linear unmixing, or channel unmixing) may be performed in various ways including but not limited to linear unmixing, principle component analysis, learning unsupervised means of spectra, support vector machines, neural networks, (spectral) phasor approach, and Monte Carlo unmixing algorithm. In order to reduce crosstalk between the fluorescent dyes associated with different markers, several techniques may be employed. The unmixing techniques are used to separate contributions from different fluorescent dyes to the same detection channel, i.e. the crosstalk due to overlapping emission spectra. Employing these techniques can greatly enhance the sensitivity of the method due to reduced noise. Further, the fluorescence lifetime and the excitation fingerprint of a fluorescent dye can be used in order to correctly identify the fluorescent dye. This can be used to employ more sets of markers per image, i.e. have more sets of markers in one set. In turn, this vastly increases the overall number of markers that can be imaged.

In another preferred embodiment the method further comprises a step of capturing a hyperspectral image of the sample. In contrast to multispectral imaging, which captures a limited number of wavelength bands, typically less than or around 10, a hyperspectral image captures tens or hundreds of wavelength bands per pixel. In other words, hyperspectral images have a very high spectral resolution. This allows for a much finer differentiation of fluorescent dyes based on their emission spectrum and thereby increases the sensitivity and reliability of the method.

In another preferred embodiment the method further comprises a step of applying the second excitation light temporally after the first excitation light. Preferably, the time between applying the first excitation light and applying the second excitation light is longer than the fluorescence lifetime of the fluorescent dyes of the first set. This ensures, that only fluorescence light emitted by the fluorescent dyes of the second set is captured for generating the second image. Thereby, crosstalk between fluorescent dyes can be reduced and the sensitivity of the method is further improved.

In another preferred embodiment at least one of the first wavelength spectrum and the second wavelength spectrum comprise a wavelength range being smaller than 50 nm, smaller than 30 nm, smaller than 10 nm or a single wavelength. These wavelength bands are typical ranges of e.g. dichroitic beam splitters or bandpass filters being used in fluorescence microscopy. Various methods can be used in order to generate the respective wavelength spectrum for sample illumination or fluorescent dye excitation. For example, a bandpass filter which filters out a wavelength range might be used in combination with a light source emitting light having a broad spectrum of wavelengths, e.g. a mercury or xenon lamp. Alternatively, or additionally, a white light laser emitting supercontinuum white light in combination with an AOTF for selecting of single wavelengths of the emitted light could be used.

In another preferred embodiment the fluorescent dyes unique to each marker in the first and/or second sub-pluralities can be excited by essentially one wavelength spectrum or by the same wavelength spectrum. This allows the fluorescent dyes of a single sub-plurality to be excited by a single light source with e.g. a narrow emission spectrum. This embodiment of the method can be easily implemented with existing fluorescence microscopes which often comprise such light sources.

In another preferred embodiment the fluorescent dyes unique to each marker in the first and/or second sub-pluralities comprise emission spectra of at least partially different wavelength ranges. Thereby, the sets of markers of a single sub-plurality can be easily distinguished from another by the emission spectra of their associated fluorescent dyes. This reduces or eliminates the computational load of the unmixing necessary to separate the channels of each image and makes the method faster and more reliable.

In another preferred embodiment at least two fluorescent dyes, each unique to one marker, have different fluorescent lifetimes. Thereby, the at least two fluorescent dyes can be distinguished from another by their lifetimes. In particular, this can be used to increase the number of channels per image, i.e. capture more markers per image. Thus, the overall number of markers that can be imaged is vastly increased. Additionally, the lifetime of the at least two fluorescent dyes can be used to correctly identify the set of markers imaged, thereby making the method more robust. In particular, existing fluorescent dyes may be engineered to generate derivative fluorescent dyes with similar excitation and/or emission spectra, but different fluorescence lifetimes by modifying the base structure or putting the fluorescent dye into a different molecular environment.

In another preferred embodiment at least two fluorescent dyes, each unique to one marker, in the first and/or second sets have emission spectra of essentially the same wavelength ranges and essentially the same fluorescent life time at a first condition of the sample, and comprise emission spectra of essentially the same wavelength ranges and substantially different fluorescent life time at a second condition. The first and second conditions may be a certain pH value, a certain redox level, certain temperature, a certain concentration of a ligand (e.g. lower concentration of one of the following Cu(II), Zn(II), a small molecule) of the sample.

In another preferred embodiment the markers within at least one marker comprise a non-fluorescent dye unique to the set. Non-fluorescent dyes may be identified by their characteristic light absorbing behavior. For example, for each set of markers, one non-fluorescent dye may be used, e.g. having a light absorbing characteristic such that this marker appears as a green or red colored area in simple transmission light (i.e. not in fluorescence light) microscopy. Thereby, the overall number of markers that can be used per round is further increased.

Embodiments of the present invention also relate to a device for analyzing a biological sample being adapted to carry out the method for analyzing a biological sample describe above. The device has the same advantages as the method and can be supplemented using the features of the dependent claims directed at the method.

In a preferred embodiment the device comprises at least one of a first light source configured to emit the first excitation light, and at least one second light source configured to emit the second excitation light. Alternatively, or additionally, the device comprises a tunable light source configured to emit the first and second excitation light. Preferably at least one of the first excitation light and the second excitation light is coherent light.

In another preferred embodiment a separation of the first and/or second images into the at least two channels is done by at least one of a spectrometer comprising a prism or a grating and at least one detector. Diffractive elements can be used to optically separate the captured fluorescence light by wavelength into distinct channels, e.g. by directing different wavelength onto different parts of a single detector or onto different detectors. Since these channels are created by detector hardware they will also be called detection channels in the following. An example for such a spectrometer arrangement for a confocal scanning microscope is disclosed e.g. in U.S. Pat. No. 6,614,526 B1.

In another preferred embodiment a separation of the first and/or second images into the at least two channels is done by at least one time-sensitive detector. Such a detectors register not only the wavelength spectrum but also the arrival time of the captured fluorescence light. They may also be time-gated, i.e. configured to register events within discrete segments of time so called time gates, enabling e.g. the determination of lifetime information from the arrival time of the captured fluorescence light. Thereby, fluorescent dyes having significantly overlapping emission spectra but different fluorescence lifetimes can be separated reliably into different channels. This further increases the number of markers that can be grouped into a single sub-plurality, i.e. imaged at the same time.

Embodiments of the present invention further relate a microscope system comprising the device for analyzing a biological sample described above. The microscope system is preferably a lens-free microscope, a light field microscope, widefield microscope, a fluorescence widefield microscope, a light sheet microscope, a scanning microscope, or a confocal scanning microscope.

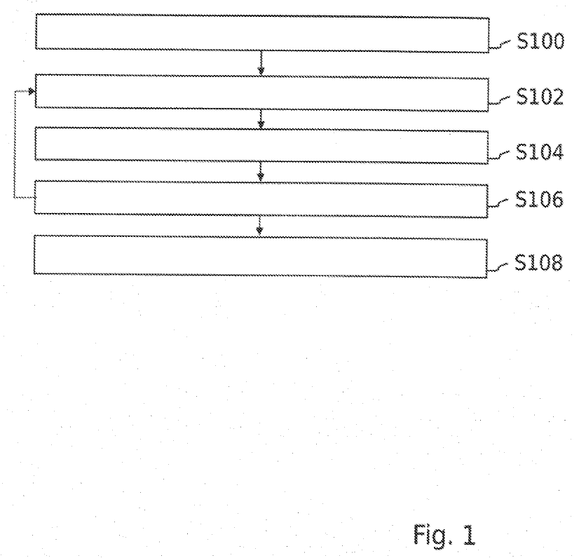

FIG. 1 is a flowchart of a method for analyzing a biological sample 1002.

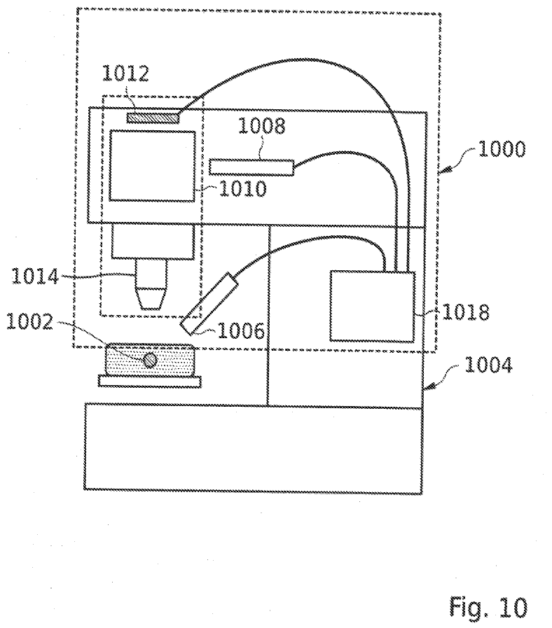

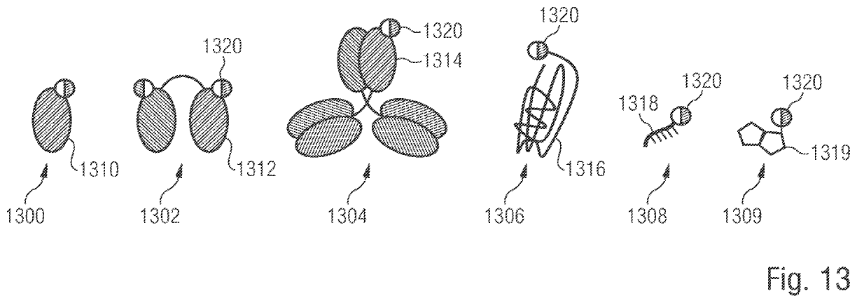

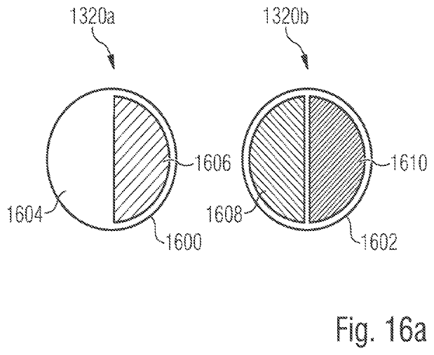

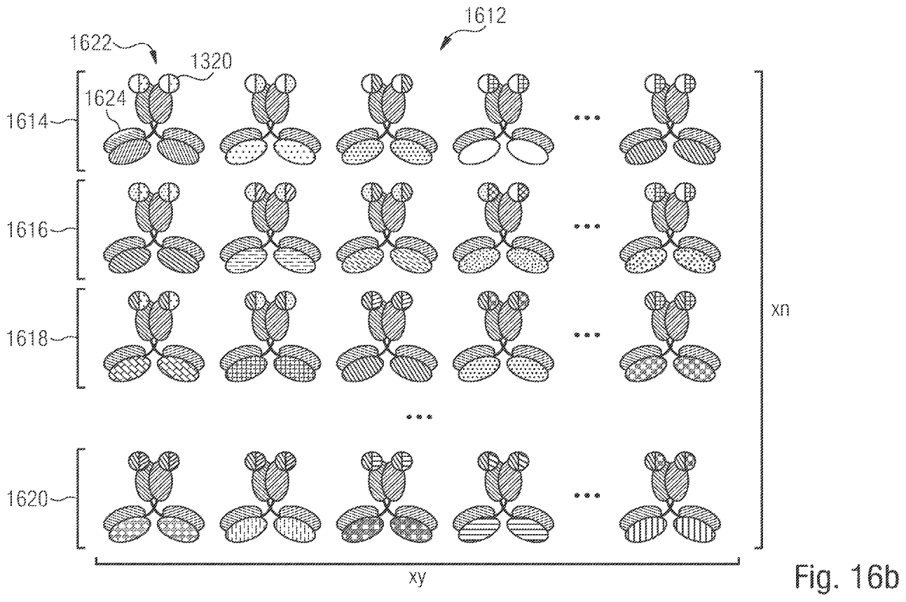

The process is started in step S100. In step S102 a plurality of markers 1612 is introduced into the sample 1002 (c.f. FIGS. 10 and 16). Each marker 1300 to 1309, 1400 to 1422, 1500 to 1508, 1518, 1526 (c.f. FIGS. 13 to 15c) comprises an affinity reagent 1310 to 1319 that is configured to attach to a predetermined structure 1706 to 1714 within the biological sample 1002. Each marker 1300 to 1309, 1400 to 1422, 1500 to 1508, 1518, 1526 further comprises a fluorescent dye 1320. The fluorescent dye 1320 is either bound directly to the affinity reagent 1310 to 1319 that attaches to the predetermined structure 1706 to 1714 or bound to a secondary affinity reagent 1510 or 1514. In the latter case, the affinity reagent 1310 to 1319 that attaches to the predetermined structure 1706 to 1714 is also called the primary affinity reagent and the secondary affinity reagent 1510 to 1518 is configured to attach to the primary affinity reagent 1310 to 1319. A few exemplary markers 1300 to 1309, 1400 to 1422, 1500 to 1508, 1518, 1526 are described below with reference to FIGS. 13 to 15c. Both the affinity reagent 1310 to 1319 or the affinity reagents 1310 to 1319, 1510 to 1518 and the fluorescent dyes 1320 are each unique to their respective markers 1300 to 1309, 1400 to 1422, 1500 to 1508, 1518, 1526, so that each marker 1300 to 1309, 1400 to 1422, 1500 to 1508, 1518, 1526 within the plurality of markers 1612 is unique. Thereby, the predetermined structure 1706 to 1714 associated with a particular marker can be identified by the fluorescent dye 1320 unique to the particular marker 1300 to 1309, 1400 to 1422, 1500 to 1508, 1518, 1526. All markers 1300 to 1309, 1400 to 1422, 1500 to 1508, 1518, 1526 are sorted into at least two different sets 1614 to 1620 (c.f. FIG. 16). Preferably, all markers 1300 to 1309, 1400 to 1422, 1500 to 1508, 1518, 1526 within one set 1614 to 1620 comprise fluorescent dyes 1320 that have excitation spectra that overlap significantly, i.e. fluorescent dyes 1320 that can be excited by the same excitation light.

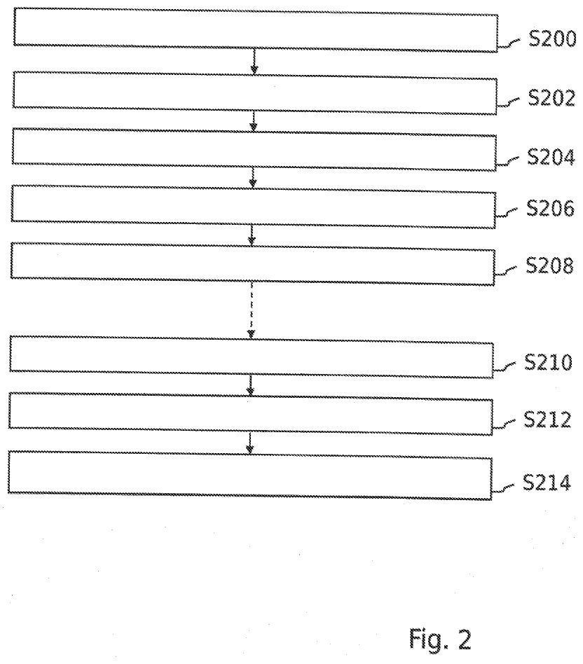

In step S104 the sets of markers 1614 to 1620 are subsequently excited and the fluorescence light emitted by the fluorescent dyes 1320 is captured. The fluorescence light captured from each set 1614 to 1620 is further separated into channels with each channel corresponding to a single marker 1300 to 1309, 1400 to 1422, 1500 to 1508, 1518, 1526. The separation into channels can be done optically, e.g. with diffractive optics, and/or computationally, e.g. by channel unmixing and/or spectral unmixing. Channels that are created optically, i.e. by detector hardware instead of computationally, are also called detection channels. Further, the separation into channels can be done based on a fluorescence lifetime, e.g. with the help of a time-resolving detector or a time-gated detector, or an excitation fingerprint of the fluorescent dyes 1320. Thus, the number of markers 1300 to 1309, 1400 to 1422, 1500 to 1508, 1518, 1526 that can be reliably separated into channels can be increased, if the fluorescent dyes 1320 of one particular set 1614 to 1620 have different lifetimes and/or emission spectra each. The information/data from the separated channels is then combined into one image of the sample 1002 for each set 1614 to 1620. These images may then be further combined into a single image of sample 1002 comprising all channels captured in step S104. Step S104 is further detailed below with reference to FIG. 2.

Optionally, following the capture of the images, the fluorescent dyes 1320 are deactivated in step S106. Deactivation is done in order to prevent the fluorescent dyes 1320 from emitting fluorescence light in the future. Methods for deactivating a fluorescent dye 1320 include bleaching the fluorescent dye 1320, either by chemically inactivating the fluorescent dye 1320 or by photophysical bleaching; or removing the fluorescent dye 1320 from the sample 1002. In order to remove the fluorescent dye 1320 from the sample 1002, the connection between the primary affinity reagent 1310 to 1319 and the predetermined structure 1706 to 1714 has to be severed. This can be done for example by antibody elution in case the affinity reagent is an antibody 1310 to 1314. Alternatively, the fluorescent dye 1320 could be removed from either the primary affinity reagent 1310 to 1319 or the secondary affinity reagent 1510 to 1518. This can be done for example through enzymatic cleaving of the peptide or oligonucleotide binding that connects the fluorescent dye 1320 and the affinity reagent 1310 to 1319, 1510 to 1518. It is also possible to reversibly bind the fluorescent dye 1320 to the affinity reagent 1310 to 1319, 1510 to 1518, e.g. through oligonucleotide hybridization and the use of barcoded antibodies.

After the fluorescent dyes 1320 have been deactivated, the process is either stopped in step S108 or the steps S102 to S106 are repeated in order to capture additional images of the sample 1002.

FIG. 2 is a flowchart further detailing step S104 of the method for analyzing a biological sample 1002 shown in FIG. 1.

The process is started in step S200. In step S202 first excitation light having a first wavelength spectrum is directed at the sample 1002. The first wavelength spectrum is selected such, that the fluorescent dyes 1320 of a first set of markers 1614 are excited to emit fluorescence light. The emitted fluorescence light is then captured and separated into the different channels in in step S204. Each channel corresponding to a single marker 1300 to 1309, 1400 to 1422, 1500 to 1508, 1518, 1526. A first image of the sample 1002 is generated by combining these channels. In step S206 second excitation light having a second wavelength spectrum is directed at the sample 1002 in order to excite the fluorescent dyes 1320 of a second set of markers 1616. Step S206 follows temporally after step S202 or after step S204. The fluorescence light emitted by the fluorescent dyes 1320 of the second set 1616 is captured and separated into the different channels in step S208. By combining the channels acquired in step S208, a second image of the sample 1002 is generated. The steps of directing excitation light at the sample 1002 and capturing the fluorescence light from the thereby excited fluorescent dyes 1320 are repeated for further excitation lights and sets of markers 1618 to 1620. In step S210 nth light having an nth wavelength spectrum is directed at the sample 1002. Thereby, the fluorescent dyes 1320 of an nth set 1620 of markers are excited and start emitting fluorescence light. This fluorescence light is captured and separated into the different channels in step S212 and the channels are combined into an nth image of the sample 1002. Following this step, the process is finished in step S214.

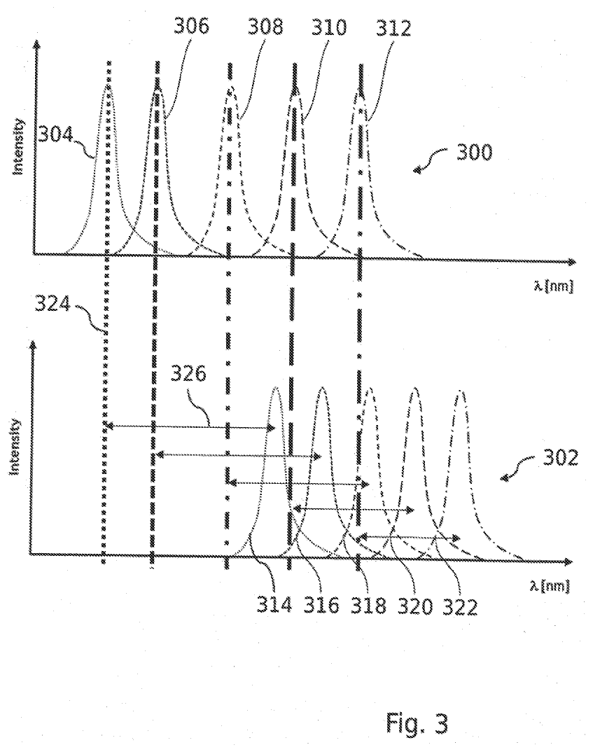

FIG. 3 shows two diagrams 300, 302 of excitation and emission spectra of five different fluorescent dyes 1320. The upper diagram shows five excitation spectra 304 to 312 of the five fluorescent dyes 1320. The excitation spectra 304 to 312 overlap but have distinct maxima. Thus, the five fluorescent dyes 1320 can be excited by five different excitation lights having five different wavelength spectra. The lower diagram shows the emission spectra 314 to 322 of the five fluorescent dyes 1320. Five lines 324 connect the upper diagram 300 and the lower diagram 302 to denote the position of the maxima of the five excitation spectra 304 to 322 in the lower diagram 302. FIG. 3 clearly shows that the maxima of the excitation 304 to 322 spectra and the maxima of the emission spectra 314 to 322 are separated by a Stokes shift, shown in FIG. 3 as double headed arrows 326. The amount of Stokes shift is about equal for each of the fluorescent dyes 1320 shown in FIG. 3.

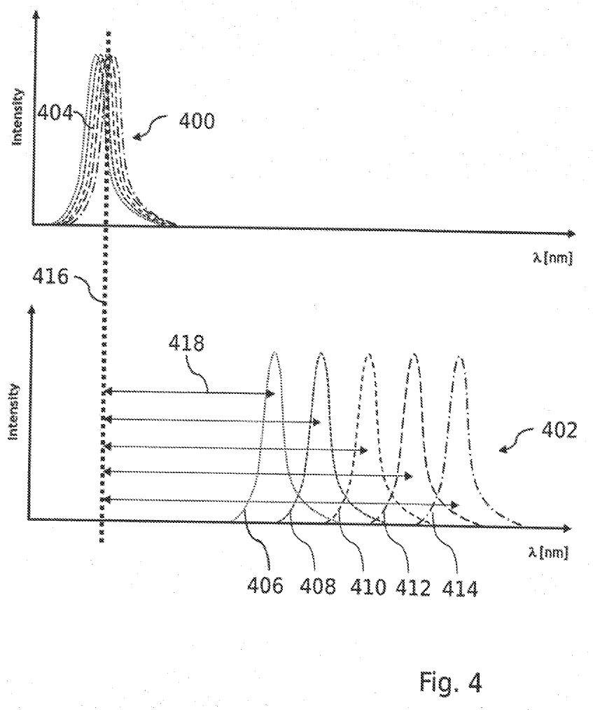

FIG. 4 shows two diagrams 400, 402 of different excitation and emission spectra of five fluorescent dyes 1320 with different amounts of Stokes shift. The upper diagram shows five excitation spectra of the five fluorescent dyes 1320. For the sake of clarity all five excitation spectra are denoted in FIG. 4 by a single reference numeral 404. The excitation spectra 404 overlap significantly and their maxima cluster around a single wavelength. Due to the overlap in their excitation spectra 404, the five fluorescent dyes 1320 can be excited with a single excitation light having a narrow wavelength spectrum or even a single wavelength. The lower diagram 402 shows the emission spectra 406 to 414 of the five fluorescent dyes 1320. A single line 416 in FIG. 4 denotes the approximate position of the maxima of the five excitation spectra 404 in the lower diagram. As can be seen in the lower diagram 402, although the excitation spectra 404 overlap significantly, the five fluorescent dyes 1320 have distinct emission spectra 406 to 414 thanks to their differing amount of Stokes shift, again denoted by double headed arrows 418. The distinct emission spectra 406 to 414 can be used to separate the fluorescence light emitted by the five fluorescent dyes 1320 into five separate channels in order to generate an image of the sample 1002. As can be seen from FIG. 4, fluorescent dyes 1320 with different amounts of Stokes shift can be used to generate multiple channels with a single excitation light. For the method described above with reference to FIGS. 1 and 2 this means, that for n excitation lights having different wavelength spectra, each exciting y different fluorescent dyes 1320 associated with a single set of markers 1614 to 1620, the total number of markers that can be reliably distinguished is n×y.

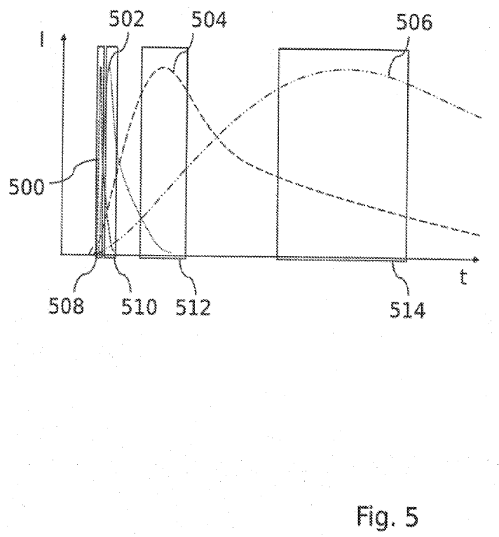

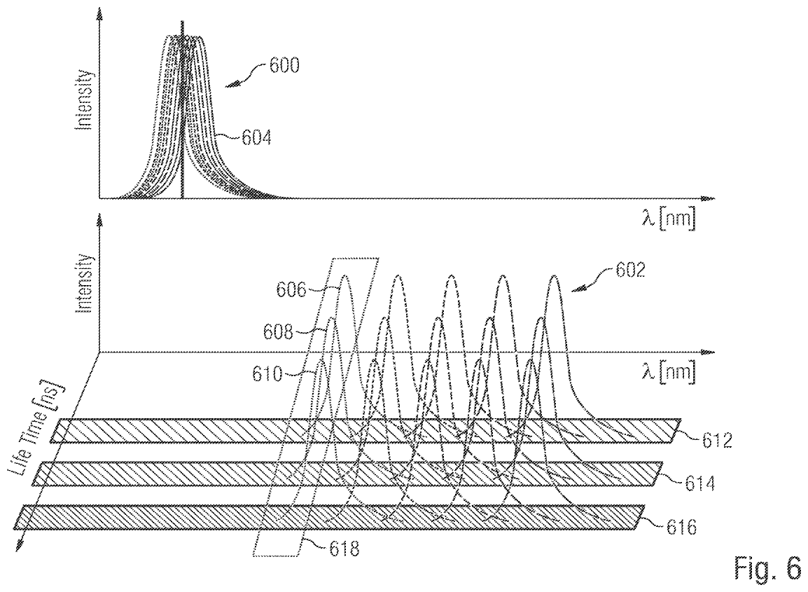

FIG. 5 is a diagram of fluorescence emission decay curves 500 to 506 of four different fluorescent dyes 1320, which can be recorded with a time-sensitive detector. A first axis t denotes fluorescence lifetime π in ns, and a second axis I denotes intensity in arbitrary units. The decay curves 500 to 506 overlap partially but their maxima are distinct. FIG. 5 illustrates how the four different fluorescent dyes 1320, that may have identical or similar emission spectra, can be distinguished by means of a time-gated detector. A time-gated detector is configured to register events within discrete segments of time so called fluorescence lifetime gates or t gates. Four fluorescence lifetime gates 508 to 514 are denoted in FIG. 5 by rectangles with a solid border. Fluorescence lifetime is orthogonal information that can be used in conjunction with spectral information from excitation or emission spectra to increase the overall number of fluorescent dyes 1320 that can be reliably separated into channels. This will be further explained below in connection with FIG. 6.

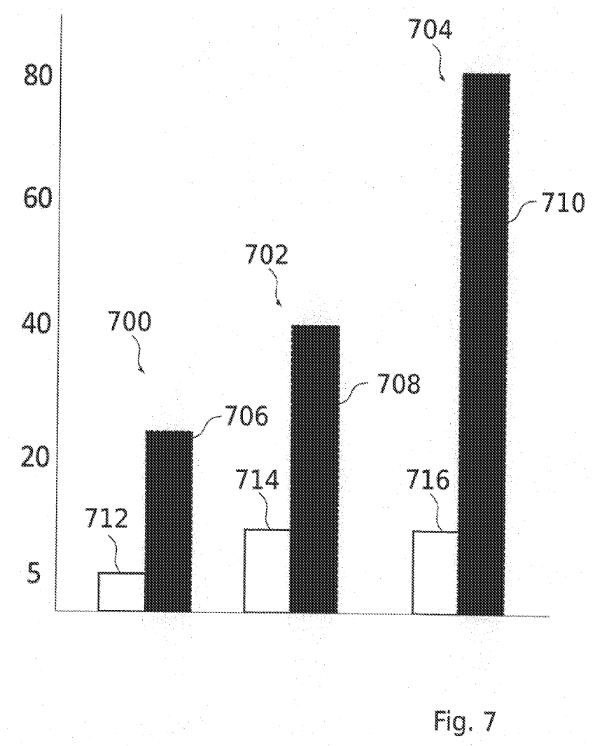

FIG. 6 shows two diagrams 600, 602 of different excitation and emission spectra 604 to 610 of fifteen fluorescent dyes 1320 grouped into three classes 612 to 616 by their fluorescence lifetime. Each class comprising five fluorescent dyes 1320 with different amounts of Stokes shift. The upper diagram shows the excitation spectra 604 of the fifteen fluorescent dyes 1320. For the sake of clarity all fifteen excitation spectra are denoted in FIG. 6 by a single reference numeral 604. As in the example described above in connection with FIG. 4, the excitation spectra 604 overlap significantly and their maxima cluster around a single wavelength and all fifteen fluorescent dyes 1320 can be excited a single excitation light. The lower diagram 602 shows the emission spectra 606 to 610 of the fifteen fluorescent dyes 1320. For the sake of clarity only the first three of all fifteen emission spectra are denoted in FIG. 6 by reference numerals. The lower diagram 602 has three axes. A first axis denotes wavelength λ in nm, a second axis denotes intensity, and a third axis denotes fluorescence lifetime π in ns. Since the fluorescent dyes 1320 grouped are grouped by fluorescence lifetime, their emission spectra 606 to 610 appear in the lower diagram in three distinct classes 612 to 616 along the third axis. These three classes 612 to 616 are denoted in the lower diagram by rectangles with solid borders in the plane defined by the first and third axes and can also be named t gates. The classes 612 to 616 can be separated with for example at least one a time-sensitive detector. Such a detector registers not only the wavelength spectrum, but also the arrival time of the captured fluorescence light. Alternatively, the detector may be time-gated, i.e. configured to register events within fluorescence lifetime gates 508 to 514. In FIG. 6 the lifetime gates 508 to 514 shown in FIG. 5 correspond to the rectangles 612 to 616 with solid borders in the lower diagram. By separating the classes 612 to 616 with a suitable detector, fluorescent dyes 1320 having significantly overlapping emission spectra 606, to 610 but different fluorescence lifetimes—such as the group of three dyes denoted in FIG. 6 the rectangle 618 with the dotted border—can be separated reliably into different channels. Referring back to the example described above in reference to FIG. 4: By using the fluorescence lifetime as an additional observable, it is possible to group more markers into a single set 1614 to 1620. Each set 1614 to 1620 may now comprise t classes of fluorescent dyes 1320 grouped by their fluorescence lifetime, each class itself comprising y different fluorescent dyes 1320 that can be excited by a single excitation light. For the method described above with reference to FIGS. 1 and 2 this means, the total number of markers that can be reliably distinguished is n×y×t. The results of the previous discussion with reference to FIGS. 4 to 6 is summarized in FIG. 7.

FIG. 7 is a diagram showing the total number of markers that can be reliably distinguished with the different embodiments of the method described above.

The diagram comprises three sub-diagrams 700 to 704, each showing the total number of distinguishable markers 1300 to 1309, 1400 to 1422, 1500 to 1508, 1518, 1526 for different numbers of detection channels, i.e. optically separated channels, excitation lights, and lifetime gates. Each sub-diagram displays the number of markers 1300 to 1309, 1400 to 1422, 1500 to 1508, 1518, 1526 distinguishable with the method described above as a solid black bar 706 to 710. Next to the solid black bar each sub-diagram 700 to 704 shows a white bar with solid border 712 to 716. The white bars 712 to 716 display the number of markers 1300 to 1309, 1400 to 1422, 1500 to 1508, 1518, 1526 that can be distinguished if the markers 1300 to 1309, 1400 to 1422, 1500 to 1508, 1518, 1526 are separated only by detection channel.

The first sub-diagram 700, i.e. the leftmost sub-diagram, shows the number of distinguishable markers 1300 to 1309, 1400 to 1422, 1500 to 1508, 1518, 1526 for 5 detection channels (y=5) and 5 excitation lights (n=5). With the method described above, the total number of distinguishable markers is n×y=25. In the second sub-diagram 702, i.e. the sub-diagram in the center, the number of detection channels is increased to 8 (y=8). Thus, with the method described above, the total number of distinguishable markers 1300 to 1309, 1400 to 1422, 1500 to 1508, 1518, 1526 is n×y=40. For the third sub-diagram 704, i.e. the rightmost sub-diagram, additionally 2 lifetime gates are used (t=2). Thereby, the total number of markers 1300 to 1309, 1400 to 1422, 1500 to 1508, 1518, 1526 distinguishable with the method described above increased to n×y×t=80. As can be seen by these examples and by comparing the solid black bars 706 to 710 to the white bars 712 to 716, the method described above the method described above vastly increases the number of distinguishable markers 1300 to 1309, 1400 to 1422, 1500 to 1508, 1518, 1526 per detection channel. This is advantageous in multiplexed biomarker analysis where the analysis of high numbers of markers 1300 to 1309, 1400 to 1422, 1500 to 1508, 1518, 1526 is desired and is to be achieved by an iterative process. For example, imaging 50 biomolecules of interest would take 10 iterative steps or rounds when the markers 1300 to 1309, 1400 to 1422, 1500 to 1508, 1518, 1526 are separated only by detection channel as opposed to 2 rounds using the method described in this document. It is important to note that, through at least one of adding further lifetime gates (t>2), a finer spectral separation of the emission light, excitation fingerprinting, the use of dedicated sets of fluorescent dyes 1320, whose physicochemical properties are optimized for the method disclosed in this document, the total number of markers 1300 to 1309, 1400 to 1422, 1500 to 1508, 1518, 1526 distinguishable with the method described above may be significantly higher than 80.

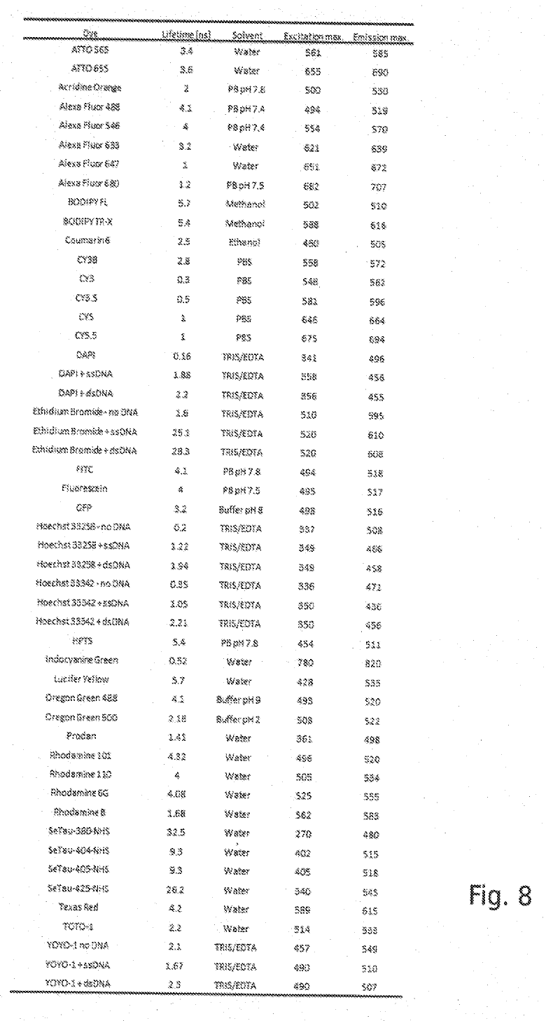

FIG. 8 is a table showing the average fluorescence lifetime, the solvent as well as the position of the excitation and emission maxima of different commercially available fluorescence dyes. This Figure has been adapted from http://www.iss.com/resources/reference/data_tables/LifetimeDataFluorophores.html.

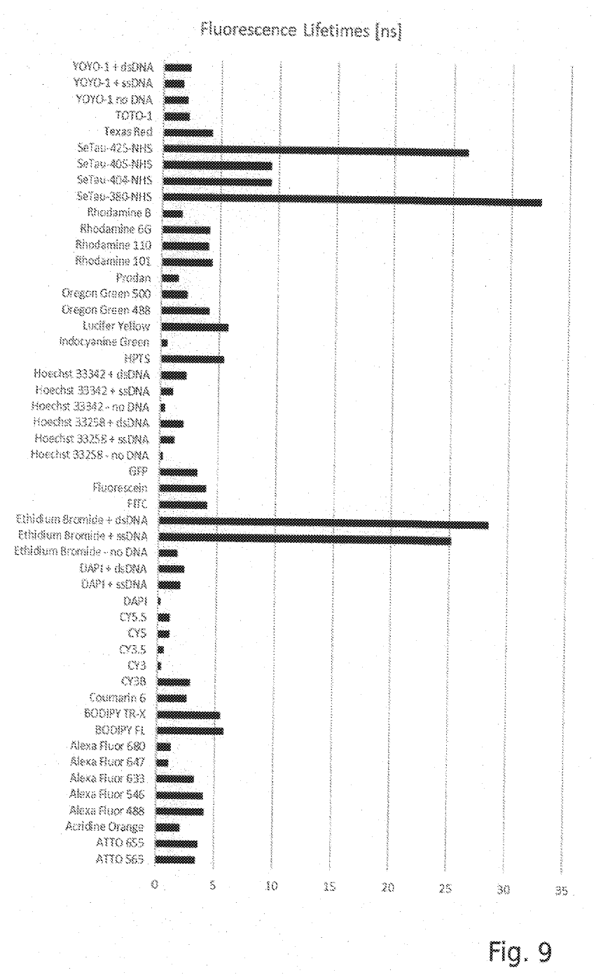

FIG. 9 is a diagram displaying the fluorescence lifetime of the different commercially available fluorescence dyes. This Figure has been adapted from http://www.iss.com/resources/reference/data_tables/LifetimeDataFluorophores.html. As can be seen from FIG. 9, it is possible to select fluorescent dyes 1320 that can be grouped by their fluorescence lifetime. For example, while most fluorescence dyes have a lifetime well below 5 ns, there are two dyes (SeTau-404-NHS and SeTau-405-NHS) with a lifetime above 5 ns but below 10 ns. Four of the listed dyes (Ethidium Bromide+dsDNA/ssDNA, SeTau-380-NHS and SeTau-425-NHS) have a life well above 10 ns. Even from this very limited list, at least three distinct classes can be selected. In this regard it is important to know that the fluorescence lifetime of a fluorescent dye can be modified by adding additional groups to the base structure of a fluorescent dye 1320 or by changing its environment. Both strategies may be employed to generate sets of fluorescent dyes 1320 that have similar spectral properties in terms of excitation and emission spectra but are distinct in terms of their fluorescence lifetime. Fluorescent dyes 1320 optimized to work in the method described in this document can be generated in this way.

FIG. 10 shows a schematic drawing of a device 1000 for analyzing a biological sample 1002. In particular, the device 1000 is capable of performing the method for analyzing a biological sample 1002 described above with reference to FIGS. 1 to 9. In FIG. 10 the device 1000 is exemplary shown as being a part of a microscope system 1004.

The device 1000 comprises a staining unit 1006 for introducing the plurality of markers 1612 into the sample 1002. For that purpose, the staining unit 1006 may comprise one or more pipettes that may or may not be automated. The device 1000 also comprises an excitation unit 1008 for exciting the fluorescent dyes 1320. The excitation unit 1008 comprises at least one light source, preferably a coherent light source. The at least one light source is configured to emit the excitation lights associated with each set of markers 1614 to 1620. In order to emit excitation light of different wavelengths or wavelength spectra, the light source may be a tunable light source. Alternatively, the device 1000 may comprise two or more light sources with emitting light of different wavelengths or wavelength spectra. In the embodiment shown in FIG. 10, the excitation lights emitted by the excitation unit 1008 is directed onto the sample 1002 by a beam splitting unit 1010.

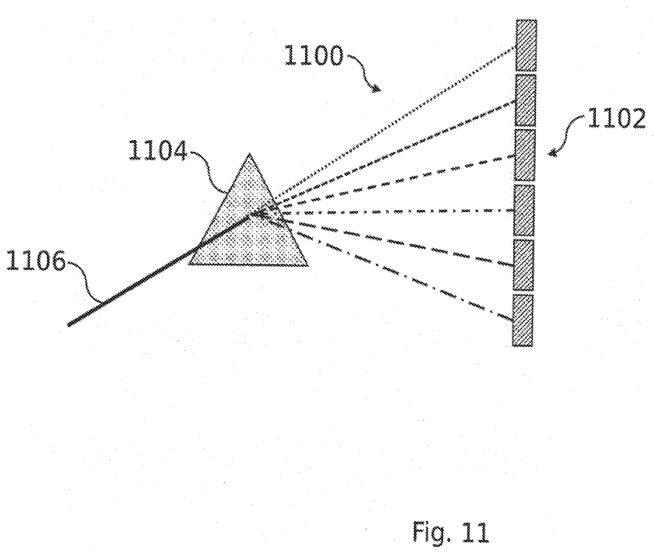

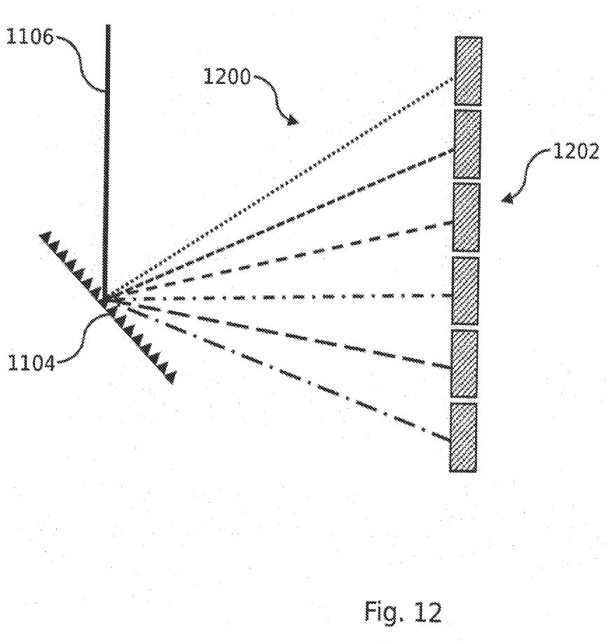

An imaging unit 1012 of the device 1000 is configured to generate images from the fluorescence light emitted by the excited dyes 1310. The imaging unit 1012 comprises an objective 1014 directed at the sample 1002 for capturing the fluorescence light. The captured fluorescence light is then directed onto a detection unit 1016 by the beam splitting unit 1010. The detection unit 1016 comprises at least one detector element and a diffractive element for splitting the fluorescence light into different detection channels. The detection unit 1016 will be described in more detail below in connection with FIGS. 11 and 12.

After imaging the sample 1002, the fluorescent dyes 1320 may need to be deactivated. This can be done for example by photo bleaching the fluorescent dyes 1320 with coherent light emitted by at least one of the light sources of the excitation unit 1008. Alternatively, a bleaching agent for chemically deactivating the fluorescent dyes 1320 can be introduced into the sample 1002 with the staining unit 1006. Further, it is possible to remove the fluorescent dye 1320 from either the primary or secondary affinity reagent 1510 to 1518. This can be done for example by introducing enzymatic cleaving agent into the sample 1002 with the staining unit 1006. Alternatively, or in additionally, the fluorescent dye 1320 may be deactivated by antibody elution or by dehybridization (i.e. melting) and elution in the case of fluorescently labeled oligonucleotides 1309. Thus, the excitation unit 1008 and/or the staining unit 1006 form a marker deactivation unit configured to deactivate at least one set of markers 1614 to 1620 present in the sample 1002.

The device 1000 further comprises a processor 1018 connected to the staining unit 1006, the excitation unit 1008 and the detection unit 1016. The processor 1018 is configured to control the elements of the device 1000 in order to perform the method for analyzing a biological sample 1002. In particular, the processor 1018 is configured to perform the method based on at least one user input.

FIG. 11 is a schematic drawing of an embodiment of the imaging unit 1100 of the device 1000 according to FIG. 10. The imaging unit 1100 according to this embodiment comprises six detector elements 1102 and a prism 1104. The prism 1104 splits the incoming fluorescence light 1106 and directs it onto the detector elements 1102 according to its wavelength. Thereby, the incoming fluorescence 1106 light is separated by wavelength into six detection channels.

FIG. 12 is a schematic drawing of another embodiment of the imaging unit 1200 of the device 1000 according to FIG. 10. The imaging unit 1200 according to this embodiment comprises six detector elements 1202 and a diffraction grating 1204. In this embodiment, the diffraction grating acts 1204 as the diffractive element splitting the incoming fluorescence 1106 light and directing it onto the detector elements 1202 according to its wavelength. Thereby, the incoming fluorescence light 1106 is separated by wavelength into six detection channels.

FIG. 13 is a schematic drawing of six markers 1300 to 1309 each comprising an affinity reagent 1310 to 1319, and a fluorescent dye 1320. The markers 1300 to 1309 will be referred to from left to right as the first to sixth markers.

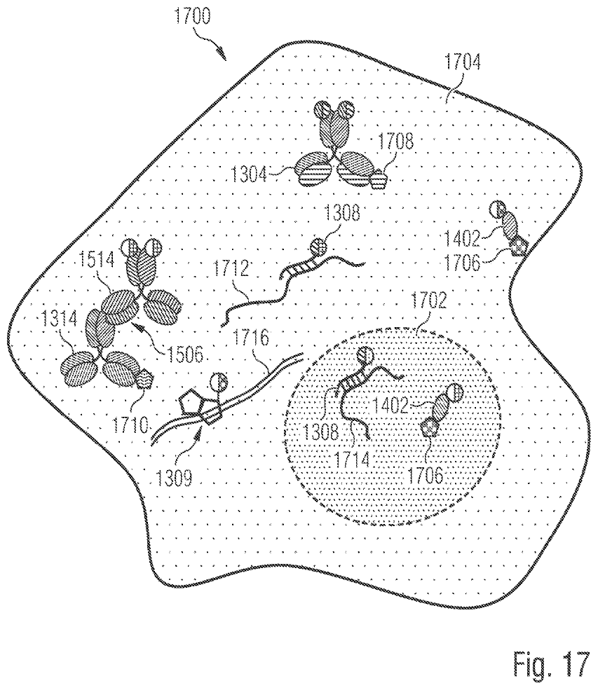

The first marker 1300 comprises a single-domain antibody 1310 (also called nanobody) as its affinity reagent. Such single domain antibodies 1310 occur naturally in species of the camelid family as well as in certain cartilaginous fishes. They can also be bioengineered from regular antibodies 1314. Compared to regular antibodies 1314 they have a much lower molecular weight. The second marker 1302 comprises a combination of two single-domain antibodies 1312 as its affinity reagent. Such combinations 1312 may be engineered in order to achieve specific affinities that are not obtainable otherwise (bispecific reactivity) or to increase avidity. In the sense of this document 1312 shall represent not only dimers but multimerized single-domain antibodies in general. The third marker 1304 comprises a regular antibody 1314 as its affinity reagent. All three markers 1300 to 1304 bind to a specific predetermined epitope 1706 to 1710 of an antigen (c.f. FIG. 17). The fourth marker 1306 comprises an aptamer 1316 as its affinity reagent. The fifth marker 1308 comprises an oligonucleotide sequence 1318 as its affinity reagent. Both aptamers 1316 and oligonucleotide sequences 1318 are complementary to a predetermined target sequence 1712, 1714 (c.f. FIG. 17) and will attach themselves to it. The sixth marker has a ligand, for example a drug molecule or a toxin 1319, as its affinity reagent, e.g. Phalloidin, a toxin that binds to an actin filament.

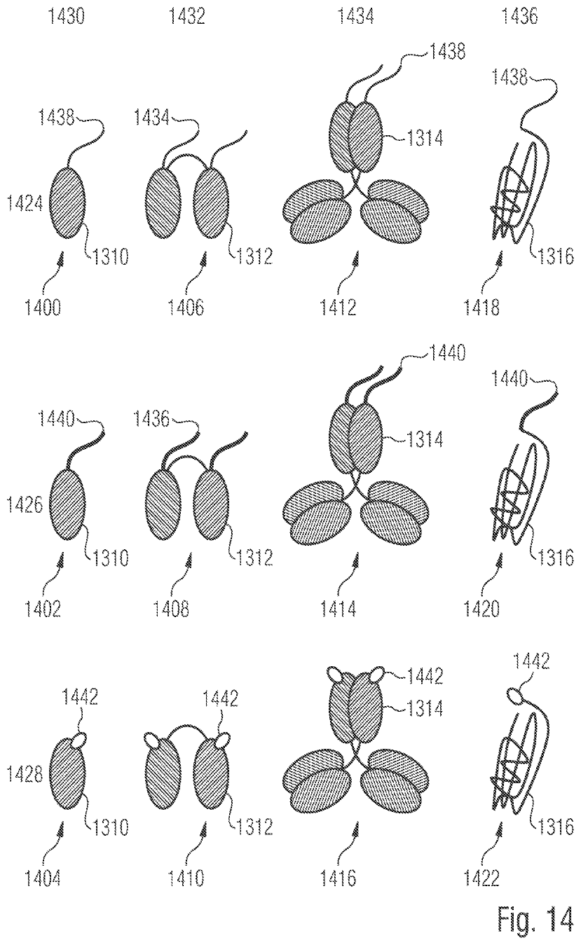

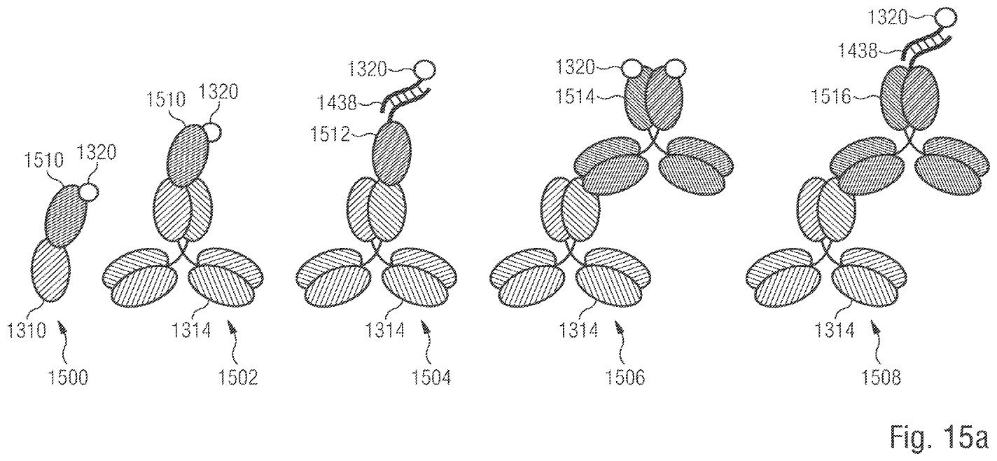

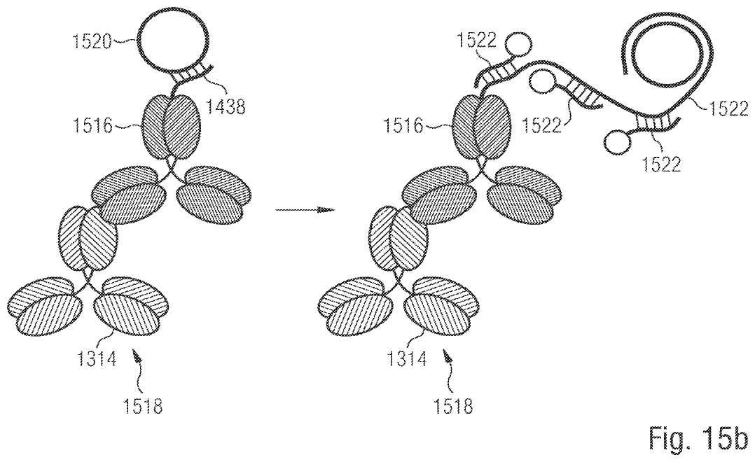

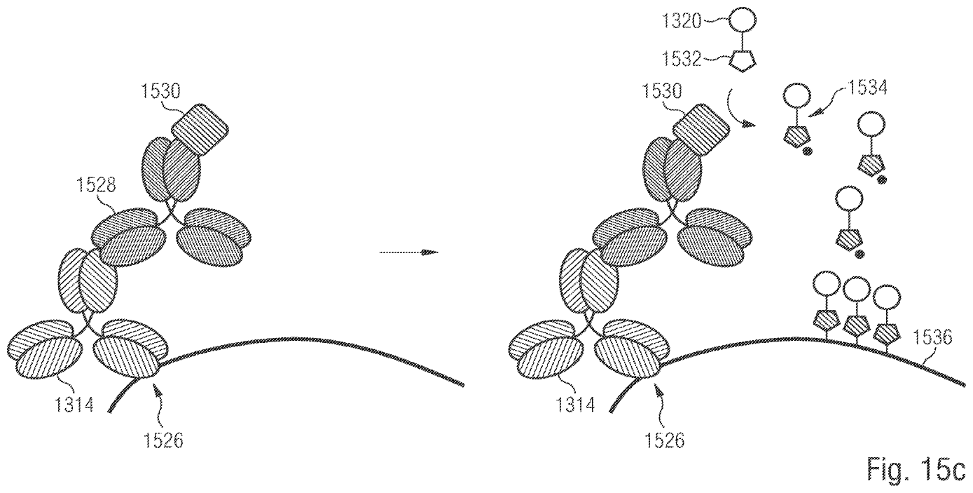

FIG. 14 is a schematic drawing of twelve markers 1400 to 1422 each comprising an affinity reagent 1310 to 1316, and an affinity tag 1438 to 1442 which is used as a target for a secondary affinity reagent, which is either directly labeled by a fluorescent dye, recognized by a fluorescent dye-conjugated tertiary affinity reagent, or carries an oligonucleotide barcode or an enzyme for label amplification as illustrated in FIGS. 15b and 15c. The markers 1400 to 1422 are arranged in three lines 1424 to 1428, labeled first to third line from top to bottom, and four columns 1430 to 1436, labeled first to fourth column from left to right.

The three markers in the same column 1430 to 1436 comprise the same affinity reagent 1310 to 1316, while the markers in the same line 1424 to 1428 comprise the same affinity tag 1438 to 1442. The markers 1400 to 1404 in the first column 1430 comprise comprises a single-domain antibody 1310 as their affinity reagent. The markers 1406 to 1410 in the second column 1432 comprise a dimer or multimer of single-domain antibodies 1312 as their affinity reagent. The markers 1412 to 1416 in the third column 1434 comprise a regular antibody 1314 as their affinity reagent. The markers in the fourth column 1436 comprise an aptamer 1316 as their affinity reagent. The markers in the first line 1424 comprise an oligonucleotide barcode 1438 as their affinity tag. The markers in the second line 1426 comprise a peptide tag 1440 as their affinity tag. The markers in the third line 1428 comprise a hapten tag 1442 as their affinity tag.

FIG. 15a is a schematic drawing of five markers each comprising a primary affinity reagent 1310m 1314 a secondary affinity reagent 1510 to 1516, and a fluorescent dye 1320. The markers will be referred to from left to right as the first to fifth markers.

The first marker 1500 comprises a single-domain antibody 1310 as its primary affinity reagent, and another single-domain antibody 1510 as its secondary affinity reagent. The another single-domain antibody 1510 is conjugated to a fluorescent dye 1320. The second to fifth markers 1502 to 1508, 1518, 1526 each comprises a regular antibody 1314 as their primary affinity reagent. The second marker 1502 comprises a single-domain antibody 1510 conjugated to a fluorescent dye 1320 as its secondary affinity reagent. The secondary affinity reagent of the third marker 1504 is a single-domain antibody 1512 with an oligonucleotide barcode 1438. A fluorescent dye 1320 is attached to the oligonucleotide 1308, which is complementary to the barcode. The fourth and fifth markers 1506, 1508 each comprise regular antibody 1514, 1516 as their secondary affinity reagent. The fluorescent dyes 1320 of the forth marker 1506 are directly attached to the antibody 1514, while the fluorescent dye 1320 of the fifth marker 1508 is attached to the antibody 1516 via an oligonucleotide barcode 1438.

Alternatively, or additionally, the fluorescent dye 1320 may be bound to a tertiary affinity reagent, which binds to a secondary affinity reagent 1512 and 1516 that binds the primary affinity reagent 1314 or 1308.

FIG. 15b shows a schematic drawing of a marker 1518 whose fluorescence signal is amplified by immuno rolling circling amplification. The secondary affinity reagent 1516 comprises an oligonucleotide barcode 1438. A circular sequence 1520 is bound to the oligonucleotide barcode 1438. After initiating the rolling circle amplification reaction, the oligonucleotide sequence of the barcode 1438 is amplified, i.e. repeatedly reproduced to form a long strand of DNA 1522 comprising multiple copies of the oligonucleotide barcode 1438. The copies then bind a multiplicity of fluorescently labeled oligonucleotides 1524.

FIG. 15c a marker 1526 whose fluorescence signal is amplified by tyramide signal amplification as an example for an enzymatic reaction in a process referred to as catalyzed reporter deposition. The marker 1526 comprises a secondary affinity reagent 1528 having a radish peroxidase enzyme 1530. The radish peroxidase enzyme 1530 converts a tyramide 1532 that is covalently linked to a fluorescent dye 1320 into a tyramide radical 1534, which is has a very short half-life and quickly couples to tyrosine side chains 1536 on the target protein or another predetermined structure 1706 to 1714.

FIG. 16a shows two fluorescent dyes 1320a, 1320b. Each fluorescent dye 1320a, 1320b is pictured as a circle 1600, 1602 with a solid border. Each circle 1600, 1602 is divided into two half circles 1604 to 1610 with different hatching. The type of hatching of the left half circles 1604, 1608 indicates the excitation light the respective fluorescent dye 1320a, 1320b can be excited with, i.e. fluorescent dyes 1320a, 1320b having left half circles 1604, 1608 with the same type of hatching can be excited with excitation light having the same wavelength spectrum or same single wavelength. The type of hatching of the right half circles 1606, 1610 indicates the characteristic properties of the respective fluorescent dye 1320a, 1320b that can be used to identify the fluorescent dye 1320a, 1320b. The characteristic properties include for example the emission spectra, the fluorescence lifetime, and the excitation fingerprint of the respective fluorescent dye 1320a, 1320b. This means, fluorescent dyes 1320a, 1320b having right half circles 1606, 1610 with the same type of hatching have the same or essentially same, i.e. indistinguishable, characteristics.

FIG. 16b shows the plurality of markers 1612. The plurality 1612 is further divided into n sets of markers 1614 to 1620. For clarity, only a first set 1614, a second set 1616, a third set 1618, and an nth set 1620 are shown in FIG. 16. Each set 1614 to 1620 comprises y markers of which only the first four markers and the yth marker are shown in FIG. 6.

For clarity, only a single marker 1622 is labelled with a reference sign. All markers 1622 within one set 1614 to 1620 can be excited with excitation light having the same wavelength spectrum or the same single wavelength. This is pictured in FIG. 16b by all fluorescent dyes 1320 of a single set 1614 to 1620 having left half circles 1604, 1608 (c.f. FIG. 16a) with the same type of hatching. Contrary thereto, all markers 1622 within one set 1614 to 1620 can be distinguished by the imaging system used for data acquisition in step S104 based on at least one of their emission spectra, fluorescence lifetime, excitation fingerprint. The maximum number of clearly distinguishable markers y depends on the properties of the fluorescent dyes 1320 and the characteristics of the imaging system used for data acquisition in step S104, which include, but are not limited to, the number of available detection channels, the spectral resolution and the availability of time-sensitive detection and a pulsed light source.

This is pictured in FIG. 16b by all fluorescent dyes 1320 of a single set 1614 to 1620 having right half circles 1606, 1610 (c.f. FIG. 16a) with different types of hatching. Further, all markers 1622 shown comprise an affinity reagent 1624 that bind to a specific structure 1706 to 1714 unique to the respective marker 1622. This is pictured in FIG. 16b by each affinity reagent 1624 having a different type of hatching.

FIG. 17 is a schematic drawing of all cell 1700 as an example for the biological sample 1002. The cell comprises a nucleus 1702 and cytoplasm 1704, each comprising structures known as epitopes 1706, 1708, 1710 to which antibodies attach themselves. This is exemplary shown for two markers 1402 that comprise single-domain antibodies 1300 that bind to epitopes 1706 located in the nucleus 1702 and the cytoplasm 1704, respectively. Both single-domain antibodies 1300 are conjugated to a molecule of the same fluorescent dye 1320, and thus belong to the same set of markers 1614 to 1620. Another marker 1304 comprises a single antibody 1314 conjugated to two molecules of the same fluorescent dye 1320. This marker 1704 is attached to an epitope 1708 in the cytoplasm 1704. Yet another marker 1506 comprises a primary antibody 1314 and a secondary antibody 1514 conjugated to two molecules of the same fluorescent dye 1320. The primary antibody 1314 is attached to an epitope 1710 in the cytoplasm 1704 and the secondary antibody 1514 is attached to the primary antibody 1314. Further, FIG. 17 shows two markers 1309 comprising fluorescently labeled oligonucleotide sequences 1309 as their affinity agents. These two markers 1309 are each attached to a complementary sequence 1712, 1714. A first of these two markers 1309 is attached to an RNA sequence 1712 in the cytoplasm 1704. A second of the two marker 1309 is attached to an DNA sequence 1714 in the nucleus 1702. A marker 1309 comprising a toxin 1319 (e.g. Phalloidin) as its affinity agent is attached to an actin filament 1716.

As used herein the term “and/or” includes any and all combinations of one or more of the associated listed items and may be abbreviated as “/”.

Although some aspects have been described in the context of an apparatus, it is clear that these aspects also represent a description of the corresponding method, where a block or device corresponds to a method step or a feature of a method step. Analogously, aspects described in the context of a method step also represent a description of a corresponding block or item or feature of a corresponding apparatus.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

LIST OF REFERENCE SIGNS

| | |
|---|---|
| 300, 302 | Diagram |
| 304, 306, 308, 310, 312 | Spectrum |
| 314, 316, 318, 320, 322 | Spectrum |
| 324 | Line |
| 326 | Arrow |
| 400, 402 | Diagram |
| 404, 406, 408, 410, 412, 414 | Spectrum |
| 416 | Line |
| 418 | Arrow |
| 500, 502, 504, 506 | Decay curve |
| 508, 510, 512, 514 | Lifetime gates |
| 600, 602 | Diagram |
| 604, 606, 608, 610 | Spectrum |
| 612, 614, 616 | Class |
| 618 | Group |
| 700, 702, 704 | Diagram |
| 706, 708, 710, 712, 714, 716 | Bar |
| 1000 | Device |
| 1002 | Sample |
| 1004 | Microscope system |
| 1006 | Staining unit |
| 1008 | Excitation unit |
| 1010 | Beam splitting unit |
| 1012 | Imaging unit |
| 1014 | Objective |
| 1016 | Detection unit |
| 1018 | Processor |
| 1100 | Imaging unit |
| 1102 | Detector element |
| 1104 | Prism |
| 1106 | Fluorescence light |
| 1200 | Imaging unit |
| 1202 | Detector element |
| 1204 | Diffraction grating |
| 1300, to 1309 | Marker |
| 1310, 1312, 1314 | Antibody |
| 1316 | Aptamer |
| 1318 | Oligonucleotide |
| 1319 | Toxin |
| 1320 | Fluorescent dye |
| 1400 to 1422 | Marker |
| 1424, 1426, 1428 | Line |
| 1430, 1432, 1434, 1436 | Column |
| 1438 | Oligonucleotide Barcode |
| 1440 | Peptide tag |
| 1442 | Hapten tag |
| 1500, 1502, 1504, 1506, 1508 | Marker |
| 1510, 1512, 1514, 1516 | Antibody |
| 1518 | Marker |
| 1520 | Sequence |
| 1522 | DNA |
| 1524 | Oligonucleotide |
| 1526 | Marker |
| 1528 | Affinity reagent |
| 1530 | Radish peroxidase enzyme |
| 1532 | Tyramide |
| 1534 | Tyramide radical |
| 1536 | Tyrosine side chain |
| 1600, 1602 | Circle |
| 1604, 1606, 1608, 1610 | Half circle |
| 1612 | Plurality |
| 1614, 1616, 1618, 1620 | Set |
| 1622 | Marker |
| 1624 | Affinity reagent |
| 1700 | Cell |
| 1702 | Nucleus |
| 1704 | Cytoplasm |
| 1706, 1708, 1710 | Epitope |
| 1712 | DNA sequence |
| 1714 | RNA sequence |
| 1716 | Actin filament |

1: A method for analyzing a biological sample, the method comprising:
providing a plurality of markers, each marker comprising a fluorescent dye unique to the marker and at least one affinity reagent unique to the marker the at least one affinity reagent being configured to attach to a predetermined structure within the biological sample;
staining the biological sample by introducing the plurality of markers into the biological sample;
directing first excitation light having a first wavelength spectrum onto the biological sample in order to excite the fluorescent dyes of a first set of markers;
generating at least one first image from fluorescence light emitted by the excited fluorescent dyes of the first set of markers, the first image comprising at least two channels, each channel corresponding to a respective marker to of the first set of markers;
directing at least one second excitation light having a second wavelength spectrum onto the biological sample in order to excite the fluorescent dyes of a second set of markers, the second set of markers being distinct from the first set of markers; and
generating at least one second image from fluorescence light emitted by the excited fluorescent dyes of the second set of markers, the second image comprising at least two channels, each channel corresponding to a respective marker of the second set of markers.

2: The method according to claim 1, wherein for at least one marker the fluorescent dye is conjugated to the at least one affinity reagent.

3: The method according to claim 1, wherein at least one marker comprises at a primary affinity reagent unique to the marker and a secondary affinity reagent unique to the marker, wherein the fluorescent dye is conjugated to the secondary affinity reagent, wherein the primary affinity reagent is configured to attach to the predetermined structure within the biological sample, and wherein the secondary affinity reagent is configured to attach to the primary affinity reagent.

4: The method according to claim 1, further comprising deactivating at least one marker of the plurality of markers.

5: The method according to claim 4, wherein the deactivating is performed by at least one of bleaching the fluorescent dye unique to the at least one marker or removing the at least one marker from the biological sample by at least one of dissociating or cleaving the fluorescent dye from the affinity reagent or dissociating the at least one affinity reagent from the predetermined structure.

6: The method according to claim 4, wherein the following steps are repeated at least twice in order to create a first series of images of the biological sample:
providing an additional plurality of markers;
staining the biological sample by introducing the additional plurality of markers into the biological sample;
directing the first excitation light onto the biological sample in order to excite the fluorescent dyes of another first set of markers; and
generating another first image from fluorescence light emitted by the excited fluorescent dyes of the another first set of markers, the another first image comprising at least two channels, each channel corresponding to one marker of the another first set of markers.

7: The method according to claim 6, wherein the following steps are repeated—at least twice in order to create a second series of images of the biological sample:
directing the second excitation light onto the biological sample in order to excite the fluorescent dyes of another second set of markers; and
generating another second image from fluorescence light emitted by the excited fluorescence dyes of the another second set of markers, the another second image comprising at least two channels, each channel corresponding to one marker of the another second set of markers.

8: The method according to claim 1, wherein the at least two channels are generated based on at least one of channel unmixing, spectral unmixing, a fluorescence lifetime of the fluorescent dyes, or an excitation fingerprint of the fluorescent dyes.

9: The method according to claim 1, further comprising capturing a hyperspectral image of the sample.

10: The method according to claim 1, wherein the second excitation light is applied temporally after the first excitation light.

11: The method according to claim 1, wherein at least one of the first wavelength spectrum or the second wavelength spectrum comprises a wavelength range that is less than 50 nm.

12: The method according to claim 1, wherein the fluorescent dyes unique to each marker in the first set of markers or the second set of markers are excitable by a same wavelength or by a same wavelength spectrum.

13: The method according to claim 1, wherein the fluorescent dyes unique to each marker in the first set of markers and/or the second set of markers comprise emission spectra of at least partially different wavelength ranges.

14: The method according to claim 1, wherein at least two fluorescent dyes, each unique to a respective marker, have different fluorescent lifetimes.

15: The method according to claim 1, wherein at least one marker comprises a non-fluorescent dye unique to the marker.

16: A device for analyzing a biological sample adapted to carry out the method according to claim 1.

17: The device of claim 16, comprising at least one of:
a first light source configured to emit the first excitation light, and at least one second light source configured to emit the second excitation light, or
a tunable light source configured to emit the first excitation light and the second excitation light.

18: The device of claim 17, wherein at least one of the first excitation light and the second excitation light is coherent light.

19: The device of claim 16, wherein the first image and/or the second image is separated into the at least two channels by a spectrometer comprising a prism or a grating and at least one detector.

20: The device of claim 16, wherein the first image and/or the second image is separated into the at least two channels by at least one time-sensitive detector.

21: A microscope system comprising the device according to claim 16, wherein the microscope system is a lens-free microscope, a light field microscope, widefield microscope, a fluorescence widefield microscope, a light sheet microscope, a scanning microscope, or a confocal scanning microscope.
